(19) United States
(12) Patent Application Publication
(10) Pub. No.: US 2016/0261674 A1
(43) Pub. Date: Sep. 8, 2016

(54) PROVIDING A HTML FILE BY PICTURE TRANSPORT PROTOCOL

(71) Applicant: Google Inc., Mountain View, CA (US)

(72) Inventor: Dmitri Plotnikov, Palo Alto, CA (US)

(21) Appl. No.: 14/640,450

(22) Filed: Mar. 6, 2015

(51) Int. Cl. H04L 29/08; G06F 17/30

(52) U.S. Cl. CPC H04L 67/06; H04L 67/141; H04L 67/02; G06F 17/30896

(57) ABSTRACT

Image editing and photo management may be implemented over a PTP and/or MTP connection as disclosed herein. A connection may be established between a client device and a portable device using, for example, PTP and/or MTP. A request to open a HTML pseudo-file on the portable device may be received. The HTML file may be provided by the portable device over the connection. The portable device may operate a web server that provides a URL to the client device and/or converts an image data file location on the portable device into a URL that can be read by a web browser operating on the client device.

### BACKGROUND

Portable electronic devices with a camera usually possess the ability to capture and store digital images. When the portable device is connected to a client device, it can utilize a protocol such as picture transport protocol (“PTP”) or media transport protocol (“MTP”). PTP is often utilized when a device with a digital camera is physically connected to a client device such as a laptop computer, desktop computer, etc. over USB or FireWire, for example. MTP is an extension of PTP and allows for transfer of digital images over wireless or wired connections. PTP, in general, abstracts the underlying file system with which the portable device is formatted to the client device. The portable device, whether it connects via PTP or MTP, is presented as a mass storage device on the client device. PTP and MTP are limited to read and/or write functions.

### BRIEF SUMMARY

According to an implementation, a connection may be established between a client device and a portable device using a protocol such as PTP or MTP. A request to open a HTML file on the portable device may be received over the connection from the client device. The portable device may return the HTML file over the connection.

A system is provided that includes a portable device and a client device. The portable device may include a computer-readable storage medium and a first processor. The storage medium may store a HTML file. The first processor may programmatically generate the HTML file. The first processor may be configured to accept a connection with a client device using a protocol PTP or MTP. The first processor may receive a request to open the HTML file stored on the storage medium over the connection from the client device. The first processor may return the HTML file over the connection. The client device may include a second processor that is configured to request opening of the HTML file and open the HTML file in a web browser.

In an implementation, a system according to the presently disclosed subject matter includes a portable device and a client device. The system may include a means for programmatically generating an HTML file. The system may have a means for establishing a connection between the client device and the portable device using a protocol such as PTP or MTP. The system may have a means for receiving a request to open a HTML file on the portable device over the connection from the client device. The system may include a means for returning the HTML file over the connection by the portable device.

Additional features, advantages, and implementations of the disclosed subject matter may be set forth or apparent from consideration of the following detailed description, drawings, and claims. Moreover, it is to be understood that both the foregoing summary and the following detailed description provide examples of implementations and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example process for embedding functionality in a portable device that communicates with a client device over PTP and/or MTP as disclosed herein.

FIG. 2 is an example of a system is for providing an HTML file to a client device via a web server operating on a portable device as disclosed herein.

FIG. 3 shows a computer according to an implementation of the disclosed subject matter.

FIG. 4 shows a network configuration according to an implementation of the disclosed subject matter.

FIG. 5 is an example configuration of a portable device and a client device as disclosed herein.

### DETAILED DESCRIPTION

Typically, a digital camera is connected to a PC or tablet over USB. The digital camera may be recognized and communicated with using PTP or MTP. PTP and MTP present the digital camera's data as a mass storage device. The host (e.g., the digital camera) can perform limited functions such as read/write files. The disclosed implementations allow photo editing and/or photo management functions to be embedded in portable devices (e.g., digital cameras, smartphones, etc.), thereby improving the functionality of PTP and/or MTP communication protocols beyond their current capabilities. A web server may be hosted by the portable device. It may convert the file names or other computer-readable representation of the captured images into web server commands and/or URLs that can be accessed by a web browser operating on a client device (e.g., a tablet, laptop computer, desktop computer, server, etc.).

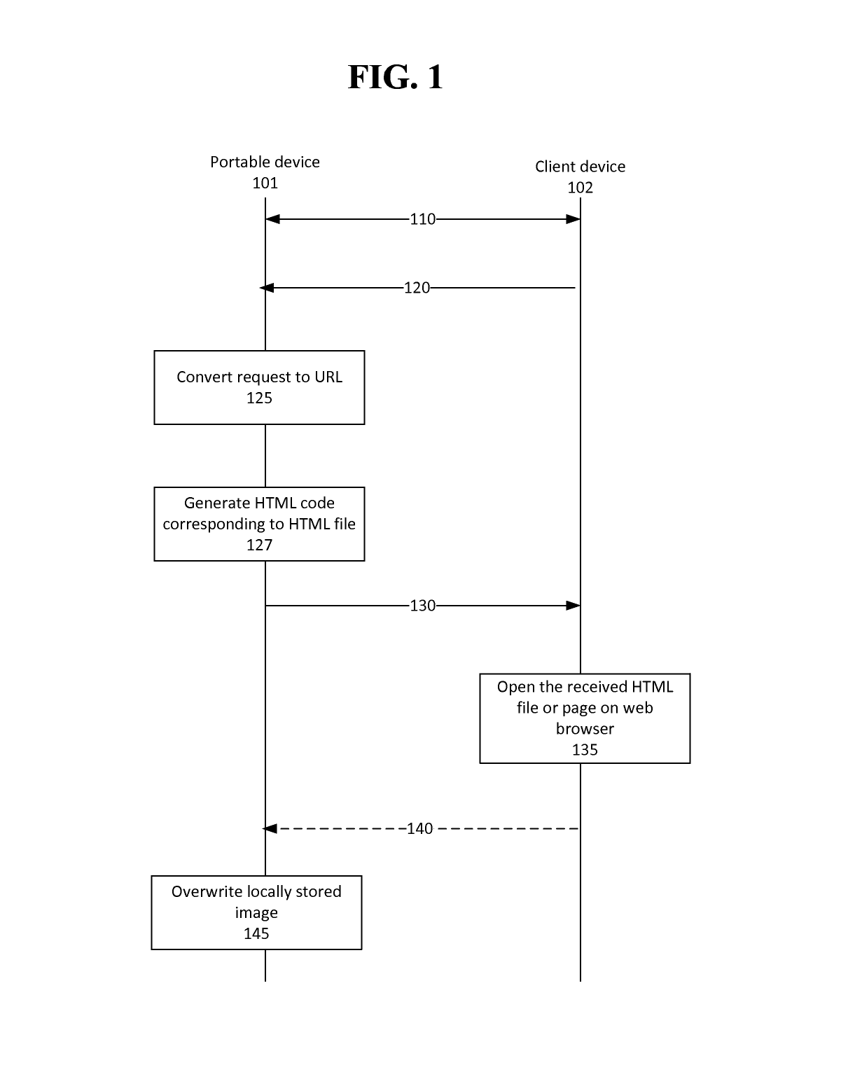

FIG. 1 is an example process for embedding functionality in a portable device 101 that communicates with a client device 102 over PTP and/or MTP. At 110, a connection may be established between a client device 102 and a portable device 101 using a protocol such as PTP or MTP. As an example, a user may connect a smartphone to a laptop computer. As stated above, a wired (e.g., USB) or wireless (e.g., Bluetooth, near-field communication, etc.) connection 110 may be made using PTP or MTP. A person of ordinary skill in the art will appreciate that there are extensions to PTP and/or MTP that can be used according to any implementation disclosed herein.

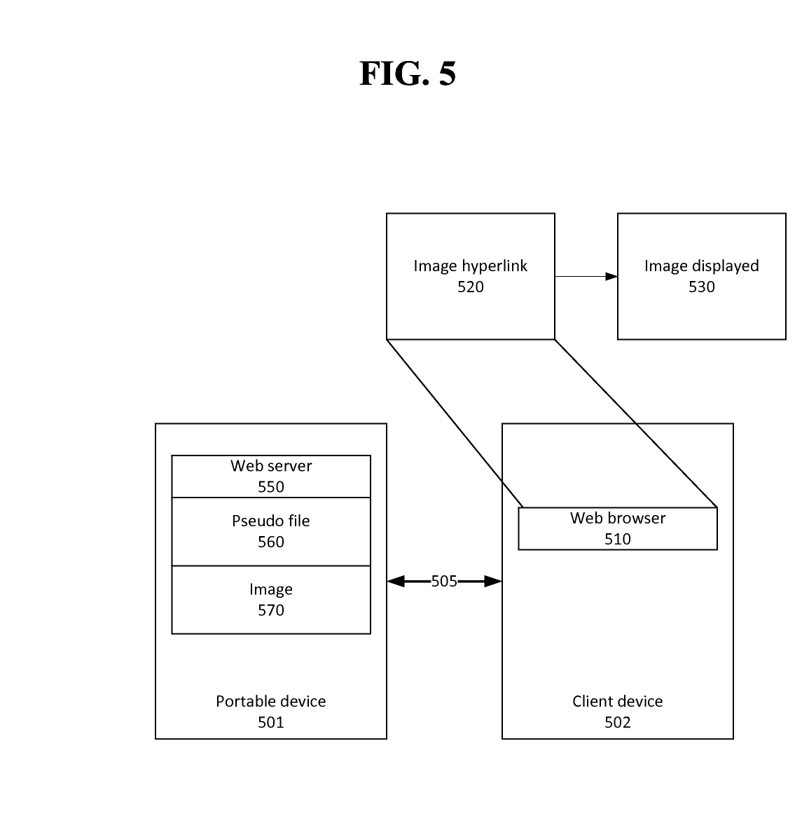

At 120, a request to open a HTML file on the portable device 101 may be received over the connection established at 110 from the client device 102. FIG. 5 is an example of a portable device 501 and a client device 502 as disclosed herein. For example, when the portable device 501 is connected to the client device 502, the portable device may become accessible via a user interface such as a file browser on the client device 502. The portable device 501 may generate a pseudo file 560 that can be displayed in a user interface, such as a browser window, as an icon. The pseudo file 560 may be called “manage photos.html” for example. The presence of this file on the portable device may be simulated by the portable device 501. A user of the client device 502 may select the HTML file to open it on the client device 502 such as by double clicking the file. In some configurations, the HTML file may be opened automatically upon connecting the portable device 501 to the client device 502 or in response to opening or viewing the contents of the mounted portable device 501.

The user's selection to open the pseudo file 560 may be received as a request by the portable device 501. The request may be converted to a URL by the portable device 101 at 125 as described below. At 130, the portable device may respond to the request by providing HTML code corresponding to the pseudo file to the client device. The portable device 101 may return HTML code corresponding to the pseudo file that can be opened on a web browser on the client device 102 The HTML code may be generated by the web server on the portable device 101 at 127.

Returning to FIG. 5, because the pseudo file 560 appears as an HTML file to the client device 502, the client device 502 may open the file in a web browser 510 operating thereon. The request to open the HTML file may be received over PTP/MTP. The portable device 501 may recognize the name of the HTML file 560 that is being requested by the client device 502. The portable device 501 may convert it to a URL (e.g., http://root) that is sent to the built-in web server 550 of the portable device 501. The web server 550 may be any computer readable code that provides content using HTTP. The code may be stored on read only memory or FLASH memory, for example, on the portable device 501. The web server 550 may return the HTML page to the web browser 510 operating on the client device 502 in response to the request received from the client device 502.

The pseudo file 560 may be displayed by the web browser 510 of the client device 502 as an image and/or hyperlink corresponding to an image 570 stored on the portable device 501. One or more URLs provided in the HTML document may correspond to file names of images on the portable device and be relative to, for example, the root URL (e.g., http://root). In FIG. 5, the hyperlink 520 for the image 570 is displayed by the web browser 510. In the event a hyperlink 520 is selected from the web browser 510 or if the web browser 510 attempts to load an image in the HTML file, the URL may be interpreted by the web server 510 on the portable device as the file name of an image stored on the portable device. The image file 570 on the portable device 501 may be converted to a URL by the web server 550 and provided in response to a request from the web browser 510 of the client device 502. The image may be displayed 530 by the web browser 510 on the client device 502 using the PTP/MTP implementation as disclosed herein. In some configurations, the image 570 may be displayed as the web browser 510 would conventionally display any image selected on the client device 502, for example, as a static image.

Alternatively or in addition, the web browser 510 may provide editing functions such as crop, delete, color adjustment, and/or photo management capabilities (e.g., organizing where the image file is stored on the portable device 501, editing a name of an image file, etc.). An edit that occurs via the web browser 510 interface on the client device 502 may be received by the web server 550 operating on the portable device 501 and as shown in FIG. 1 at 140. Such communications may occur via selection of links and the translation of those links to and from pseudo filenames as previously described. For example, a request to edit the image via the web browser 510 may be received as a HTTP request by the web server 550. The web server 550 may adjust the image 570 according to the requested edit. In the event a user elects to save an edit (or photo management), the web server 550 may overwrite the existing image data file 570 on the portable device 501 with the modified version of the image file 510 and as shown in FIG. 1 at 145.

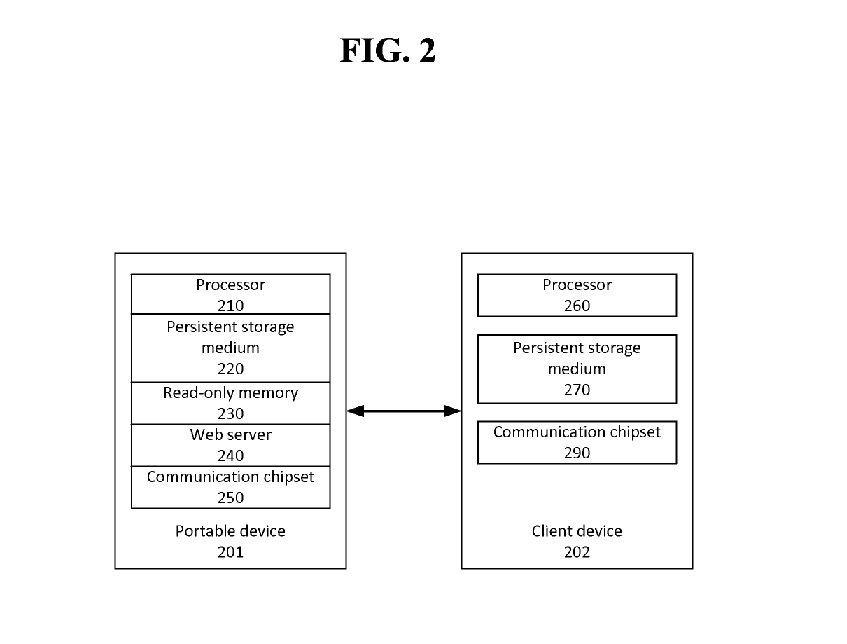

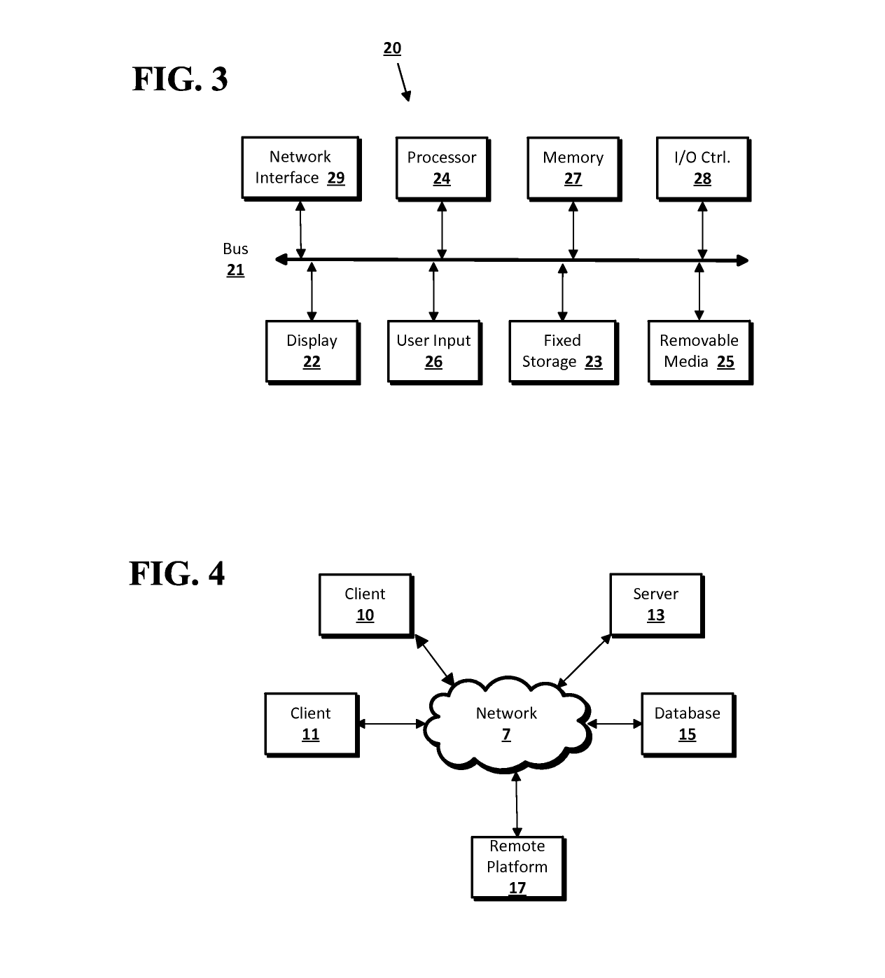

In an implementation, a system is disclosed that includes a portable device (e.g., a digital camera, a smartphone, a tablet, etc.) and a client device (e.g., a laptop computer, a tablet, a desktop computer, etc.). An example configuration of the system is provided in FIG. 2. The portable device 201 may include a persistent storage medium 220 that is communicatively coupled to a processor 210 such as by a system bus as shown in FIG. 3 (described below). The storage medium 220 may contain a HTML file as described above. The HTML file may be generated by the processor 210. The read only memory 230 may contain machine-readable code necessary to operate a web server 240 on the portable device 201 as described above. The portable device may include a communication chipset 250 such as a USB, Bluetooth, and/or NFC chipset that can receive and send requests and/or data by the connection established by the communication chipset 250.

The processor 210 may be configured to establish a connection with a client device 202 using a protocol such as PTP and/or MTP as described above. The processor 210 may direct the communication chipset 250 to establish a connection with the communication chipset 290 of the client device 202. The client device 202 may send a request to open the HTML file stored on the storage medium. The request may be received by the communication chipset 250 of the portable device 201. The processor 210 may return the HTML file via the established connection to the client device 202. The client device 202 may contain a processor 260 and a storage medium 270. The processor 260 may request the HTML file to be opened as described earlier. The HTML file may be opened by the processor 260 in a web browser operating on the client device 202.

Implementations of the presently disclosed subject matter may be implemented in and used with a variety of component and network architectures. FIG. 3 is an example computer 20 suitable for implementations of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection, or the like. For example, the network interface 29 may allow the computer to communicate with other computers via one or more local, wide-area, or other networks, as shown in FIG. 4.

Many other devices or components (not shown) may be connected in a similar manner (e.g., document scanners, digital cameras, and so on). Conversely, all of the components shown in FIG. 3 need not be present to practice the present disclosure. The components can be interconnected in different ways from that shown. The operation of a computer such as that shown in FIG. 3 is readily known in the art and is not discussed in detail in this application. Code to implement the present disclosure can be stored in computer-readable storage media such as one or more of the memory 27, fixed storage 23, removable media 25, or on a remote storage location.

FIG. 4 shows an example network arrangement according to an implementation of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A computer-implemented method, comprising:
establishing a connection between a client device and a portable device using a protocol selected from the group consisting of: a picture transport protocol (PTP) and a media transport protocol (MTP);
receiving over the connection, from the client device, a request to open a HTML file on the portable device; and
returning over the connection, by the portable device, HTML code corresponding to the HTML file.

2. The method of claim 1, further comprising converting, by the portable device, a name of the HTML file into a URL responsive to the request.

3. The method of claim 1, wherein the HTML file comprises at least one of a hyperlink and an image.

4. The method of claim 1, wherein the portable device is a digital camera, a tablet, or a mobile phone.

5. The method of claim 4, further comprising:
receiving, by the digital camera, a selection of a hyperlink corresponding to a file name of an image stored on the digital camera; and
displaying, on the client device, the file using picture transport protocol.

6. The method of claim 4, further comprising receiving, by a client device, an edit request by a web browser.

7. The method of claim 6, further comprising receiving, by the portable device, an edited version of an image that is locally stored on a storage medium on the portable device.

8. The method of claim 7, further comprising overwriting the locally stored image with the edited image.

9. The method of claim 1, further comprising generating, by the web server on the portable device, HTML code corresponding to the HTML file.

10. A system, comprising:
a portable device comprising
a storage medium for storing an HTML file;
a first processor configured to:
accept a connection from a client device using a protocol selected from the group consisting of: a picture transport protocol (PTP) and a media transport protocol (MTP);
receive over the connection, from the client device, a request to open the HTML file stored on the storage medium; and
return HTML code corresponding to the HTML file over the connection; and
the client device comprising a second processor configured to:
request opening of the HTML file; and
open the HTML code corresponding to the HTML file in a web browser.

11. The system of claim 10, the first processor further configured to convert a name of the HTML file into a URL responsive to the request.

12. The system of claim 10, wherein the HTML file comprises at least one of a hyperlink and an image.

13. The system of claim 10, wherein the portable device is a digital camera, a tablet, or a mobile phone.

14. The system of claim 13, the second processor further configured to:
receive a selection of a hyperlink corresponding to a file name of an image stored on the digital camera; and
provide, by the processor for display by the client device, the file using picture transport protocol.

15. The method of claim 10, the second processor further configured to receive an edit request by the web browser.

16. The system of claim 15, the first processor further configured to receive an edited version of an image that is locally stored on a storage medium.

17. The system of claim 16, the first processor further configured to overwrite the locally stored image with the edited image.

18. The system of claim 10, the processor further configured to generate HTML code corresponding to the HTML file.
